(19) United States
(12) Patent Application Publication
(10) Pub. No.: US 2013/0249827 A1
(43) Pub. Date: Sep. 26, 2013

(54) MULTI-MODE DISPLAY APPARATUS AND ELECTRONIC PRODUCT HAVING THE SAME

(71) Applicant: SAMSUNG DISPLAY CO., LTD., Yongin-City (KR)

(72) Inventors: Yong-Ju JEONG, Seoul (KR); Soo-Ran PARK, Asan-si (KR); Sangchul LEE, Yongin-si (KR); Minsung CHOI, Cheonan-si (KR)

(73) Assignee: SAMSUNG DISPLAY CO., LTD., Yongin-City (KR)

(21) Appl. No.: 13/758,786

(22) Filed: Feb. 4, 2013

(30) Foreign Application Priority Data
Mar. 22, 2012 (KR) 10-2012-0029442

(51) Int. Cl. G06F 3/041

(52) U.S. Cl. CPC G06F 3/0414
USPC 345/173

(57) ABSTRACT

A display apparatus includes a display panel, a timing controller, and an impact sensor. The impact sensor senses an external impact and is connected to an input terminal of the timing controller. When the impact is sensed, the display panel displays a white color during a predetermined time period. In addition, an electronic product further includes a body and a door with the display apparatus. The display apparatus is coupled to the door. Accordingly, light leakage, which can occur in a display apparatus due to external impact, may be prevented.

### CROSS-REFERENCE TO RELATED APPLICATION

This U.S. non-provisional patent application claims priority under 35 U.S.C. §119 to Korean Patent Application No. 10-2012-0029442, filed on Mar. 22, 2012, the entire contents of which are hereby incorporated by reference.

### BACKGROUND

1. Field of disclosure

The present disclosure relates generally to a display apparatus and an electronic product having the same. More particularly, the present disclosure relates to a transparent display apparatus for a door, and an electronic product having the transparent display apparatus.

2. Description of the Related Art

One form of display is known as a transparent display apparatus, which being transparent allow people to see objects located behind it, as well as display images. The transparent display apparatus can be classified into a non-self-emissive transparent display apparatus which uses a separate light source, e.g., a liquid crystal display, and a self-emissive transparent display apparatus which does not require a separate light source, e.g., an organic electroluminescent display.

Ongoing efforts exist to integrate transparent display apparatuses into various other electronic products. For instance, a transparent display apparatus can be integrated into a door of a refrigerator, so that a user can recognize the stored goods inside the refrigerator through the transparent display apparatus, and can also see information displayed by the display.

### SUMMARY

The present disclosure provides a display apparatus capable of maintaining display quality regardless of external impact.

The present disclosure provides an electronic product having the display apparatus.

Embodiments of the inventive concept provide a display apparatus including a display panel, a controller, and an impact sensor. The impact sensor is connected to an input terminal of the controller to sense an external impact. Once the impact is sensed, the display panel displays a white color for a predetermined time period.

Embodiments of the inventive concept provide an electronic product that further includes a body and a door. The body includes an inner space and an opening through which the inner space is exposed. The door is disposed corresponding to the opening, and the door opens and shuts to respectively expose or close off the inner space from the outside. The display apparatus is coupled to the door.

According to embodiments, the display apparatus includes a display panel, a controller, and a sensing unit. The sensing unit is connected to an input terminal of the controller to sense a user input. The display panel displays a white color or another predetermined image such as a commercial image while the user input is sensed.

According to embodiments, an electronic product further includes a body and a door with the display apparatus. The body includes an inner space and an opening through which the inner space is exposed. The door is disposed corresponding to the opening, and the door opens and shuts to respectively expose or close off the inner space from the outside. The display apparatus is coupled to the door.

According to embodiments, an electronic product includes a body, a door, and a display apparatus. The display apparatus includes a display panel, a controller, and a switching device. The display apparatus is operated in a first mode to display a white color once the door opens, and is operated in a second mode to display a conventional image once the door shuts. The signal applied to an input terminal of the switching device determines whether the first mode or the second mode is employed.

According to the above, light leakage, which occurs in the display apparatus as a result of external impact, may be prevented.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view showing an electronic product according to an exemplary embodiment of the present invention;

FIG. 2 is a block diagram illustrating the electronic product shown in FIG. 1;

FIG. 3 is a timing diagram showing an impact signal and a white enable signal according to an exemplary embodiment of the present invention;

FIG. 4 is a perspective view showing an electronic product according to another exemplary embodiment of the present invention;

FIG. 5 is a block diagram illustrating the electronic product shown in FIG. 4;

FIG. 6 is a timing diagram showing a white enable signal according to another exemplary embodiment of the present invention;

FIG. 7 is a perspective view showing an electronic product according to another exemplary embodiment of the present invention;

FIG. 8 is a block diagram illustrating the electronic product shown in FIG. 7; and

FIG. 9 is a timing diagram showing a white enable signal according to another exemplary embodiment of the present invention.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

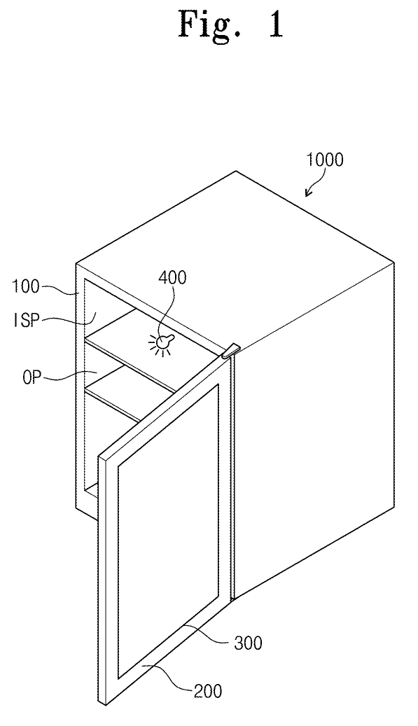

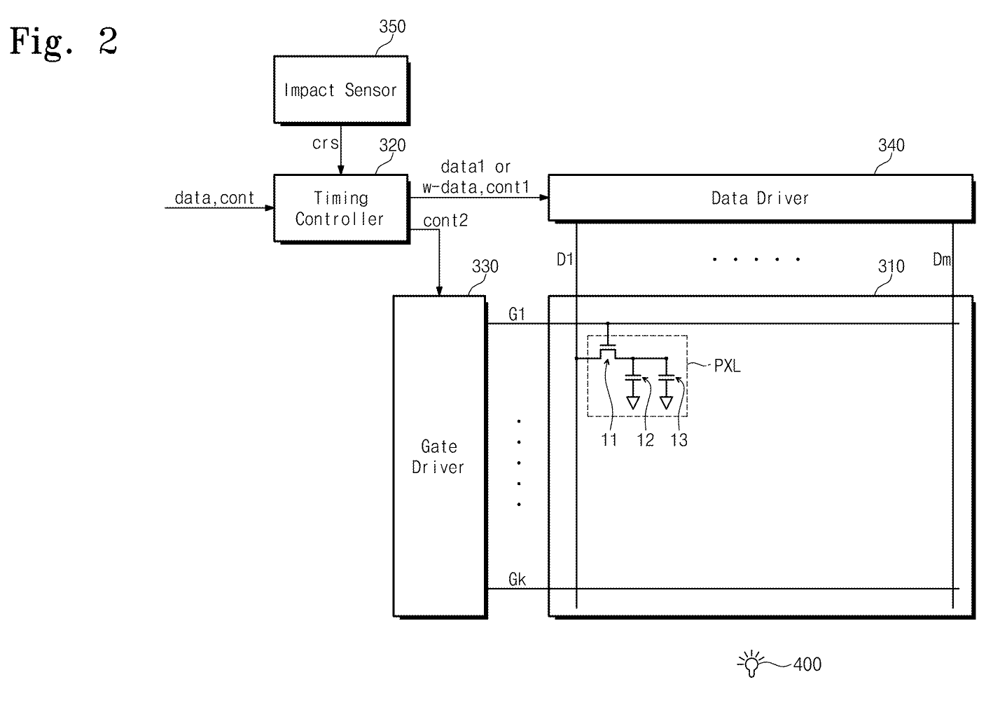

FIG. 1 is a perspective view showing an electronic product according to an exemplary embodiment of the present invention, and FIG. 2 is a block diagram illustrating the electronic product shown in FIG. 1.

Referring to FIGS. 1 and 2, the electronic product 1000 includes a body 100, a door 200, and a display apparatus 300.

The electronic product 1000 shown is a refrigerator, but may be any device, such as a refrigerator, a washing machine, a microwave, or an oven.

The body 100 includes an inner space ISP, in which beverages or foods are stored, and an opening OP through which the inner space ISP is exposed.

The door 200 prepared corresponding to the opening OP opens and shuts to expose or seal the inner space ISP. The door 200 may be hinge-coupled to one side of the body 100.

The display apparatus 300 is equipped within at least a portion of the door 200. Accordingly, the display apparatus 300 partially performs the function of the door 200. The display apparatus 300 is operated in a first mode or a second mode, which are different from each other, to display an image. The display apparatus 300 displays a white color (or is otherwise opaque) in the first mode.

The display apparatus 300 includes a display panel 310, a timing controller 320, a gate driver 330, a data driver 340, and an impact sensor 350.

The display panel 310 displays the image. The display panel 310 includes a display area and a non-display area (the boundary between these two areas is not shown) adjacent to at least a portion of the display area. The display area is disposed to correspond to the opening OP. The display panel 310 may be any type of display panel, such as a liquid crystal display panel, an organic light emitting display panel, a plasma display panel, an electrophoresis display panel, an electrowetting display panel, etc. In the present exemplary embodiment, the display panel 310 is a liquid crystal display panel.

The display panel 310 includes a plurality of gate lines G1 to Gk applied with a gate signal and a plurality of data lines D1 to Dm applied with a data voltage. The gate lines G1 to Gk are insulated from the data lines D1 to Dm while crossing the data lines D1 to Dm. The display panel 310 includes a plurality of pixel areas arranged in a matrix layout, and pixels are arranged in the pixel areas, respectively. FIG. 2 shows an equivalent circuit of one pixel PXL. The pixel PXL includes a thin film transistor 11, a liquid crystal capacitor 12, and a storage capacitor 13.

Although not shown in FIGS. 1 and 2, the thin film transistor 11 includes a gate electrode, a source electrode, and a drain electrode. The structure, composition, and operation of thin film transistors are known. The gate electrode is connected to a first gate line G1 of the gate lines G1 to Gk, the source electrode is connected to a first data line D1 of the data lines D1 to Dm, and the drain electrode is connected to the liquid crystal capacitor 12 and the storage capacitor 13. The liquid crystal capacitor 12 and the storage capacitor 13 are connected to the drain electrode in parallel.

In addition, the display panel 310 includes a first display substrate, a second display substrate facing the first display substrate, and a liquid crystal layer interposed between the first display substrate and the second display substrate.

The gate lines G1 to Gk, the data lines D1 to Dm, the thin film transistor 11, and a pixel electrode (not shown), which serves as a first electrode of the liquid crystal capacitor 12, are disposed on the first display substrate. The thin film transistor 11 applies the data voltage to the pixel electrode in response to the gate signal.

A common electrode (not shown), which serves as a second electrode of the liquid crystal capacitor 12, is disposed on the second display substrate, and a reference voltage is applied to the common electrode for image display. The liquid crystal layer is disposed between the pixel electrode and the common electrode to serve as a dielectric substance. The liquid crystal capacitor 12 is charged with a voltage corresponding to an electric potential difference between the data voltage and the reference voltage.

The display panel 310 displays a white color in the first mode.

The impact sensor 350 senses an external impact and generates an impact signal crs upon detecting such an impact, and the impact sensor 350 applies the impact signal crs to the timing controller 320. In addition, an output terminal of the impact sensor 350 is connected to an input terminal of the timing controller 320. The impact sensor 350 may be any impact sensor, such as one or more accelerometers, transducers, strain gauges, or the like. The display apparatus 300 may receive such an impact when, for example, the door 200 opens or shuts. In this case, the impact sensor 350 senses the external impact and generates the impact signal crs as a result, and the impact sensor 350 applies the impact signal crs to the timing controller 320. When the impact signal crs is output from the impact sensor 350, the display apparatus 300 is operated in the first mode for a predetermined time period. The display apparatus 300 is operated in the second mode while no impact signal crs is output from the impact sensor 350.

The timing controller 320 receives an image data data, a control signal cont, and the impact signal crs. The control signal cont includes a horizontal synchronization signal, a vertical synchronization signal, a main clock signal, and a data enable signal.

The timing controller 320 applies a data control signal cont1, such as an output start signal, a horizontal start signal, a horizontal clock signal, a polarity inverting signal, etc., to the data driver 340 and applies a gate control signal cont2, such as a vertical start signal, a vertical clock signal, a vertical clock bar signal, etc., to the gate driver 330.

The timing controller 320 generates a white enable signal (not shown) having a high level during a predetermined time period and a low level during a remaining time period, where the white enable signal is generated in response to the impact signal crs. The white enable signal (not shown) is used to control a time during which the display apparatus 300 is operated in the first mode and a time period during which the display apparatus 300 is operated in the second mode.

In the first mode, the timing controller 320 reads out a white data (not shown), which corresponds to the white color, from a memory installed therein in response to the impact signal crs. Then, the timing controller 320 converts a data format of the white data (not shown) to a data format appropriate to an interface between the data driver 340 and the timing controller 320, and provides the data driver 340 with the converted white data w-data. The impact signal crs may be used to control an output start timing of the white data w-data. The timing controller 320 outputs the white data w-data during the high period of the white enable signal.

In the second mode, the timing controller 320 converts a data format of the image data data into a data format appropriate to the interface between the timing controller 340 and the timing controller 320, and applies the converted image data data1 to the data driver 340 during the low period of the white enable signal.

The gate driver 330 is electrically connected to the gate lines G1 to Gk disposed on the display panel 310 to apply the gate signal to the gate lines G1 to Gk. In detail, the gate driver 330 generates the gate signal used to drive the gate lines G1 to Gk on the basis of the gate control signal cont2 provided from the timing controller 320, and sequentially outputs the gate signal to the gate lines G1 to Gk in units of at least one line.

In the first mode, the data driver 340 converts the white data w-data to a white voltage in response to the data control signal cont1 from the timing controller 320, and applies the white voltage to the data lines D1 to Dm.

In the second mode, the data driver 340 converts the image data data1 to a data voltage in response to the data control signal cont1 from the timing controller 320, and applies the data voltage to the data lines D1 to Dm.

The electronic product 1000 may further include a light source 400 to provide light to the inner space ISP and the display apparatus 300. The light source 400 serves not only as an indoor light of the refrigerator but also as a backlight for the display apparatus 300. In this example, since the liquid crystal display panel is a non-self-emissive type panel, the light source 400 is included and configured to function as a backlight. However, in the case that the display panel 310 is an organic light emitting display panel some other self-emissive type display, the light source 400 may be omitted.

The light source 400 may be configured to include a light emitting diode (LED) or a cold cathode fluorescent lamp (CCFL).

At least a portion of the display apparatus 300 is transparent or semi-transparent. In detail, at least the display area (not shown) of the display panel 310 is transparent or semi-transparent. Accordingly, the user may recognize the stored goods accommodated in the inner space ISP through the display apparatus 300 even when the door 200 is shut.

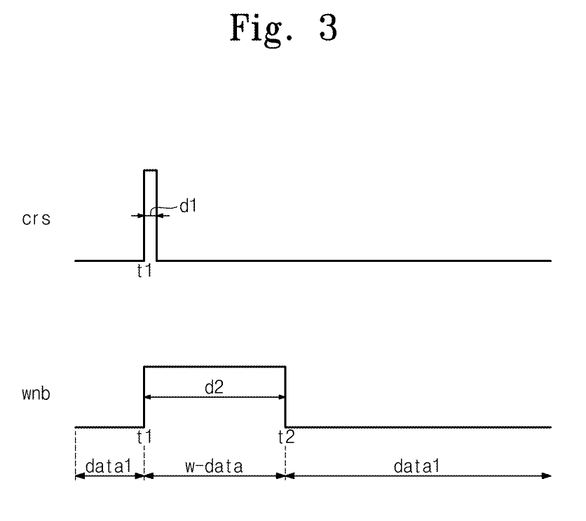

Hereinafter, the operation of the display apparatus 300 in the first mode and the second mode will be described in detail with reference to FIGS. 2 and 3.

FIG. 3 is a timing diagram showing the impact signal crs and the white enable signal according to an exemplary embodiment of the present invention.

In FIG. 3, the display apparatus 300 receives an impact at a first time point t1. Before the time point t1, the timing controller 320 converts the image data data and provides the converted image data data1 to the data driver 340. The white enable signal wnb is low, and the display apparatus 300 is operated in the second mode so as to display a conventional image.

Then, when the impact occurs at the first time point t1, the impact sensor 350 senses the external impact and generates the impact signal crs, and the impact signal crs is applied to the timing controller 320. The timing controller 320 generates white enable signal wnb having a high period d2 from the first time point t1 to the second time point t2 on receiving the impact signal crs. The high period d2 may be a predetermined time period in the timing controller 320. The timing controller 320 provides the converted white data w-data to the data driver 340 during the high period d2 of the white enable signal wnb. The high period d2 may be set to be longer than the pulse width d1. In this case, the display apparatus 300 is operated in the first mode to display the white color.

After the second time point t2, the white enable signal wnb goes low, and the timing controller 320 provides the converted image data data1 to the data driver 340. In this case, the display apparatus 300 is operated in the second mode to display the conventional image.

In a conventional electronic product, when the display apparatus is impacted such as by shutting the door, the alignment of liquid crystal molecules in the display panel is twisted. Consequently, light incident into the display panel leaks out through the panel, and the user perceives the light, resulting in an undesired visual effect.

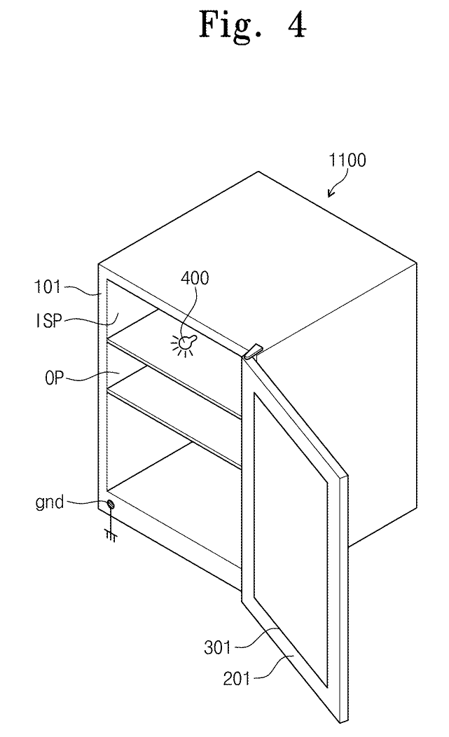

In the case of the electronic product according to the present exemplary embodiment, the display apparatus 300 may display the white color during a predetermined time period after the impact. Thus, although the alignment of the liquid crystal molecules in the display panel 310 is twisted and light leaks out, the user perceives the white color, but does not perceive light leakage. The light leakage occurring in the electronic product by the external impact may thus be reduced or eliminated. In addition, since the white color has a relatively high transmittance when compared with the other colors, the user may still perceive the stored goods in the inner space ISP of the electronic product 1000 while the display apparatus 300 displays the white color. Hereinafter, an electronic product according to another exemplary embodiment will be described with reference to FIGS. 4 to 6.

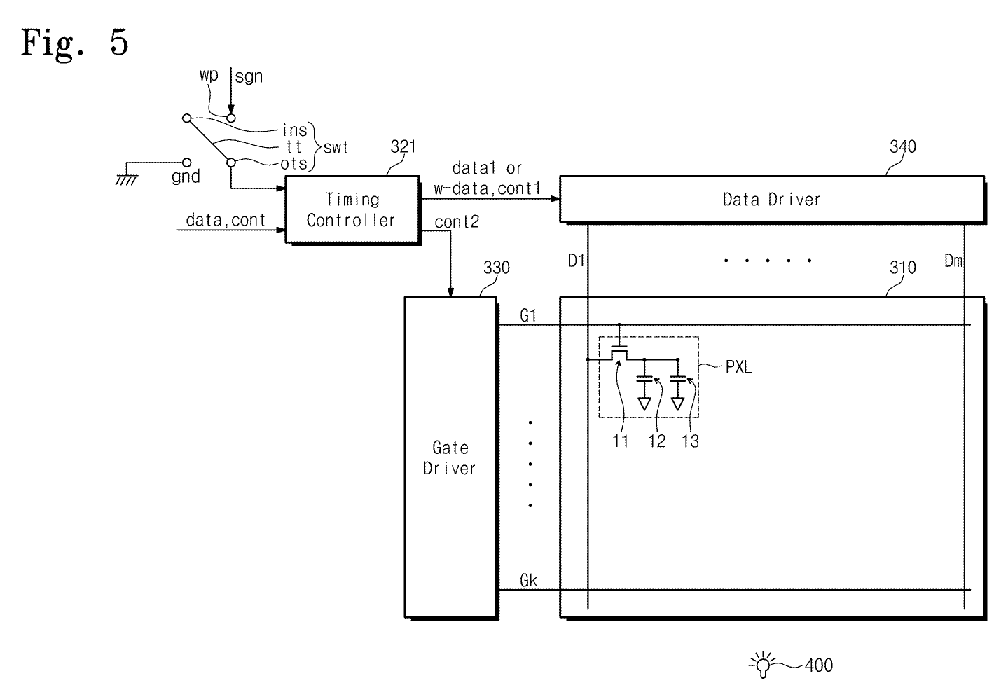

FIG. 4 is a perspective view showing an electronic product according to another exemplary embodiment of the present invention, and FIG. 5 is a block diagram illustrating the electronic product shown in FIG. 4. The electronic product 1100 has the same configuration and function as the electronic product 1000 shown in FIGS. 1 and 2, except that a ground portion gnd and a switching device swt are added to the electronic product 1100 and the electronic product 1100 does not include the impact sensor. Accordingly, the differences between the electronic product 1000 and the electronic product 1100 will be largely what is described below.

Referring to FIGS. 4 and 5, the electronic product 1100 includes a body 101, a door 201, and a display apparatus 301.

The body 101 further includes the ground portion gnd connected to a ground. The ground portion gnd is separated from the display apparatus 301 when the door 201 opens, and makes contact with at least a portion of the display apparatus 301 when the door 201 shuts.

The electronic product 1100 further includes the switching device swt connected to an input terminal of the timing controller 321.

The switching device swt includes an output terminal ots, an input terminal ins, and a switch tt. The output terminal ots is connected to the input terminal of the timing controller 321.

The input terminal ins is connected to the ground portion gnd or a white terminal wp. The white terminal wp receives a switching signal sgn, which is used to control the output timing of the white data (not shown), from a source external to the timing controller 321. When the input terminal ins is connected to the white terminal wp, the timing controller 321 receives the switching signal sgn. In this case, the display apparatus 301 is operated in the first mode so as to display the white color.

When the input terminal ins is instead connected to the ground portion gnd, the input terminal ins is grounded and the switching signal sgn is not applied to the timing controller 321. Thus, the display apparatus 301 is operated in the second mode, so that a conventional image is displayed on the display apparatus 301.

The timing controller 321 generates the white enable signal (not shown) in response to the switching signal sgn. The white enable signal (not shown) is high while the input terminal ins is connected to the white terminal wp, and is low while the input terminal ins is not connected to the white terminal wp. The white enable signal (not shown) is used to control a time during which the display apparatus 301 is operated in the first mode and a time period during which the display apparatus 301 is operated in the second mode.

The door 201 may serve as the switch tt. In detail, the input terminal ins is electrically connected to the white terminal wp when the door 201 opens. When the door 201 shuts, the input terminal ins is electrically connected to the ground portion gnd. Thus, the node to which the input terminal ins is connected is decided according to whether the door 201 is open or shut.

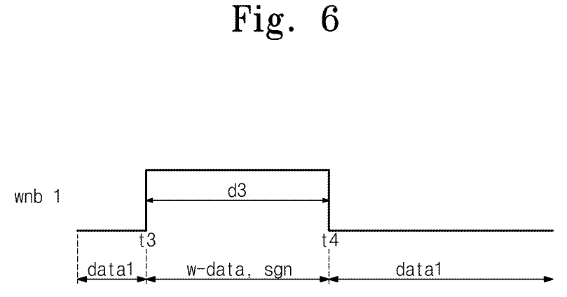

Hereinafter, the operation of the display apparatus 301 in the first mode and the second mode will be described in detail with reference to FIGS. 5 and 6.

FIG. 6 is a timing diagram showing a white enable signal according to another exemplary embodiment of the present invention.

In FIGS. 5 and 6, the door 201 is shut prior to a third time point t3, opens during a time period d3 from the third time point t3 to a fourth time point t4, and shuts again after the fourth time point t4.

Prior to the third time point t3, the input terminal ins is connected to the ground portion gnd so as to be grounded. The timing controller 321 converts the image data data to the converted image data data1, and provides the converted image data data1 to the data driver 340. The white enable signal wnb 1 is low during this time. In this case, the display apparatus 301 is operated in the second mode to display a conventional image.

When the input terminal ins is connected to the white terminal wp after the third time point t3, the timing controller 321 receives the switching signal sgn. The timing controller 321 generates a high white enable signal wnb1 from the third time point t3 to the fourth time point t4 in response to the switching signal sgn. The high period d3 corresponds to the time period during which the timing controller 321 receives the switching signal sgn. The timing controller 321 provides the converted white data w-data to the data driver 340 during the high period d3 of the white enable signal wnb1. In this case, the display apparatus 301 is operated in the first mode to display the white color.

After the fourth time point t4, the white enable signal wnb1 goes low again, and the timing controller 321 provides the converted image data data1 to the data driver 340. In this case, the display apparatus 301 is operated in the second mode to display the conventional image once more.

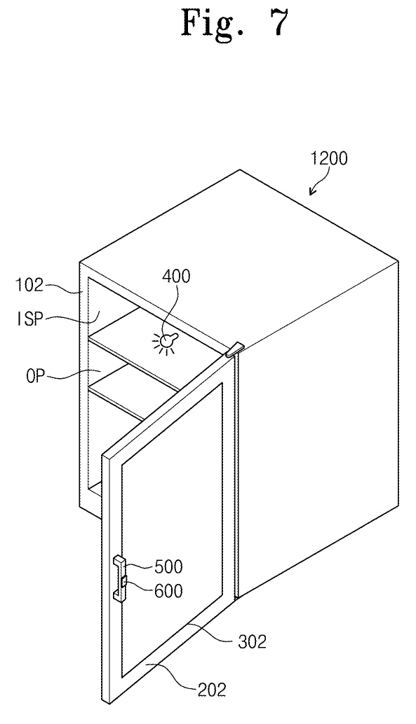

Hereinafter, an electronic product according to another exemplary embodiment of the present invention will be described in detail with reference to FIGS. 7 to 9.

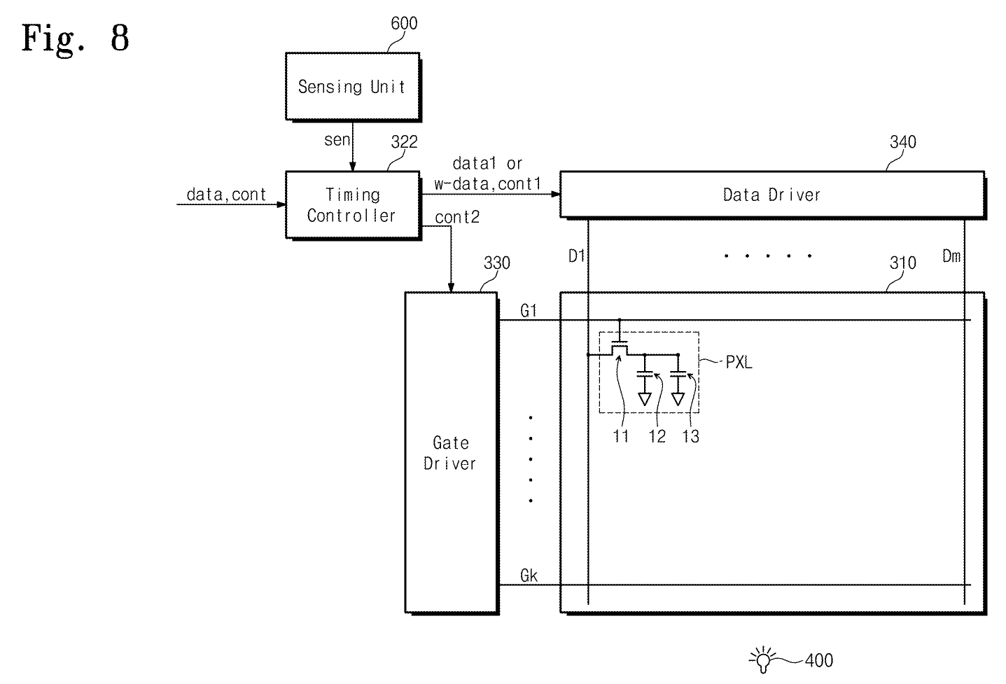

FIG. 7 is a perspective view showing an electronic product according to another exemplary embodiment of the present invention, and FIG. 8 is a block diagram illustrating the electronic product shown in FIG. 7. The electronic product 1200 has the same configuration and function as the electronic product 1000 shown in FIGS. 1 and 2, except that a knob 500 and a sensing unit 600 are added to the electronic product 1200, and the electronic product 1200 does not include the impact sensor. Accordingly, the differences between the electronic product 1000 and the electronic product 1200 will be largely what is described below.

Referring to FIGS. 7 and 8, the electronic product 1200 includes a body 102, a door 202, and a display apparatus 302.

The door 202 may further include a knob or handle 500. The knob 500 may have various shapes as long as the door 202 easily opens and shuts by the user. In FIG. 7, the knob 500 is protruded from, i.e. extends outward from, a surface of the door 202.

The display apparatus 302 may further include the sensing unit 600. The sensing unit 600 senses an input from the user. The sensing unit 600 is disposed on the knob 500, but it should not be considered as limited thereto or thereby. The sensing unit 600 may be configured to include various input devices, such as a touch sensor, an input button, etc. Accordingly, the sensing unit 600 may sense the user's input without being limited to the input method of the user. In the present exemplary embodiment, the sensing unit 600 is disposed at a center of the knob 500 (though it may be disposed at any other suitable location in, on, or around the knob/handle 500) and includes the touch sensor as shown in FIG. 7.

In addition, an output terminal of the sensing unit 600 is connected to an input terminal of the timing controller 322. When the user touches the sensing unit 600, the sensing unit 600 detects this touch and generates a sensing signal sen in response. The sensing signal sen is applied to the timing controller 322. The sensing unit 600 may output the sensing signal sen during a time period in which the user's input is sensed, i.e. while the user is touching the knob 500. When the sensed signal sen is output from the sensing unit 600, the display apparatus 302 is operated in the first mode, and the display apparatus 302 is operated in the second mode when the sensed signal sen is not output from the sensing unit 600. Thus, the display apparatus 302 operates in the first mode while the user touches the knob 500, and operates in the second mode otherwise.

The timing controller 322 generates the white enable signal (not shown) on the basis of the sensed signal sen. The white enable signal (not shown) is high while the timing controller 322 receives the sensing signal sen, and is low while the timing controller 322 does not receive the sensing signal sen. The white enable signal (not shown) is used to control a time during which the display apparatus 302 is operated in the first mode and a time period during which the display apparatus 302 is operated in the second mode.

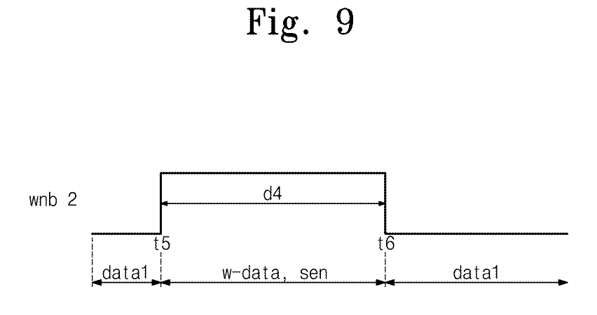

Hereinafter, the operation of the display apparatus 302 in the first mode or the second mode will be described in detail with reference to FIGS. 8 and 9.

FIG. 9 is a timing diagram showing a white enable signal wnb2 according to another exemplary embodiment of the present invention.

In FIGS. 8 and 9, the user does not touch the sensing unit 600 before a fifth time point T5, touches the sensing unit 600 during a time period from the fifth time point t5 to a sixth time point t6, and does not touch the sensing unit 600 after the sixth time point t6.

Before the fifth time point t5, the timing controller 322 converts the image data data and provides the converted image data data1 to the data driver 340. The white enable signal wnb2 is low. In this case, the display apparatus 302 is operated in the second mode to display a conventional image.

After the fifth time point t5, the sensing unit 600 senses the user's input, e.g. touch, and generates the sensed signal sen. The sensed signal sen is applied to the timing controller 322. The timing controller 322 generates the white enable signal wnb2 having a high level d4 during the time period from the fifth time point t5 to the sixth time point t6 in response to the sensed signal sen. The high period d4 corresponds to a time period during which the timing controller 322 receives the sensed signal sen. The timing controller 322 provides the converted white data w-data to the data driver 340 during the high period d4 of the white enable signal wnb2. In this case, the display apparatus 302 is operated in the first mode to display the white color.

After the sixth time point t6, the white enable signal wnb2 goes low and the timing controller 322 provides the converted image data data1 to the data driver 340. In this case, the display apparatus 302 is operated in the second mode to display a conventional image.

Incorporated into the electronic product 1200, the display apparatus 302 displays a white color from the time point at which the user's input is sensed. Accordingly, the display apparatus 302 displays the white color prior to a time point at which the impact is applied to the display apparatus 30 so as to prevent the occurrence of light leakage, which is caused by the opening and shutting of the door 202. In addition, the user stops displaying the image, such as commercials, on the display apparatus by touching the sensing unit 600, and then the user recognizes the stored goods in the electronic product.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a display panel configured to display an image;
a controller configured to receive an image signal and to control the display panel; and
an impact sensor having an output terminal connected to an input terminal of the controller to sense an external impact, wherein the controller directs the display panel to display a white color during a predetermined time period in response to sensing of the impact.

2. The display apparatus of claim 1, wherein the controller is configured to convert a white data corresponding to the white color and output the converted white data during a first time period after the impact is sensed, and the controller is further configured to convert the image signal and output the converted image signal during a second time period different from the first time period.

3. The display apparatus of claim 2, wherein at least a portion of the display panel is transparent or semi-transparent.

4. A display apparatus comprising:
a display panel configured to display an image;
a controller configured to receive an image signal and to control the display panel; and
a sensing unit having an output terminal connected to an input terminal of the controller to sense a user input, wherein the controller directs the display panel to display a white color while the user input is sensed.

5. An electronic product comprising:
a body that includes an inner space and an opening through which the inner space is exposed;
a door disposed corresponding to the opening, the door configured to open and shut to respectively expose or close off the inner space from the outside; and
a display apparatus coupled to the door and configured to operate in a first mode or a second mode different from the first mode, wherein the display apparatus displays a white color during operation in the first mode.

6. The electronic product of claim 5, further comprising a light source disposed in the inner space to provide a light to the display apparatus.

7. The electronic product of claim 5, wherein at least a portion of the display apparatus is transparent or semi-transparent.

8. The electronic product of claim 5, wherein the display apparatus is operated in the first mode during a predetermined time period after an external impact is sensed.

9. The electronic product of claim 8, wherein the display apparatus comprises:
a display panel that displays the image;
a controller configured to receive an image signal and to control the display panel; and
an impact sensor having an output terminal connected to an input terminal of the controller to sense the external impact.

10. The electronic product of claim 9, wherein the controller is configured to convert a white data corresponding to a white color and output the converted white data during a first time period after the impact is sensed, and the controller is further configured to convert the image signal and output the converted image signal during a second time period different from the first time period.

11. The electronic product of claim 5, wherein the display apparatus is operated in the first mode once the door opens and operated in the second mode once the door shuts.

12. The electronic product of claim 11, wherein the display apparatus comprises:
a display panel configured to display the image;
a controller configured to receive an image signal and control the display panel; and
a switching device having an output terminal connected to an input terminal of the controller.

13. The electronic product of claim 12, wherein the controller is configured to convert a white data corresponding to a white color and output the converted white data in the first mode, and is configured to convert the image signal and output the converted image signal in the second mode.

14. The electronic product of claim 13, wherein an input terminal of the switching device receives a switching signal so as to initiate the first mode and to thereby determine an output timing of the white data, and is grounded in the second mode.

15. The electronic product of claim 14, wherein the body comprises a ground portion connected to ground, and wherein the input terminal of the switching device is electrically connected to the ground portion once the door shuts.

16. The electronic product of claim 5, wherein the display apparatus is operated in the first mode when a user input is sensed.

17. The electronic product of claim 16, wherein the display apparatus is operated in the first mode during a time period in which the user input is sensed.

18. The electronic product of claim 17, further comprising a sensing unit disposed on the door to sense the user input.

19. The electronic product of claim 18, wherein the display apparatus comprises:
a display panel configured to display the image; and
a controller configured to receive an image signal and to control the display panel, wherein an output terminal of the sensing unit is connected to an input terminal of the timing controller.
